(19) United States
(12) Patent Application Publication
(10) Pub. No.: US 2020/0378899 A1
(43) Pub. Date: Dec. 3, 2020

(54) GLASS PROCESSING APPARATUS AND METHODS

(71) Applicant: CORNING INCORPORATED, CORNING, NY (US)

(72) Inventors: Yongjin Cho, Seoul (KR); Namhui Kim, Gyeonggi-do (KR); Taekmin Kwon, Seoul (KR)

(21) Appl. No.: 16/604,240

(22) PCT Filed: Apr. 16, 2018
(86) PCT No.: PCT/KR2018/004374

§ 371 Date: Oct. 10, 2019

(30) Foreign Application Priority Data
Apr. 14, 2017 (KR) 10-2017-0048705
Apr. 13, 2018 (KR) 10-2018-0043160

(51) Int. Cl. G01N 21/88; G01N 21/958; G01N 21/45

(52) U.S. Cl. CPC G01N 21/8806; G01N 2021/8841; G01N 21/455; G01N 21/958

(57) ABSTRACT

A cover glass inspecting apparatus may include a transfer module for transferring a cover glass. The cover glass may include a flat plate portion extending in first and second directions crossing with each other and edge portions protruding in a third direction perpendicular to the first and second directions and connected to outer circumference of the flat plate portion, wherein the flat plate portion may include first and second surfaces facing each other. The cover glass inspecting apparatus may further include a first optical module for photographing the first surface, a second optical module for photographing the second surface, and a control module for reading images of the cover glass taken by the first optical module and the second optical module. The first optical module may include a first sub optical module for photographing the first surface and a second sub optical module for photographing the edge portions.

### TECHNICAL FIELD

The inventive concept relates to a cover glass inspection apparatus, and more particularly, to a cover glass inspection apparatus which may automatically inspect a cover glass by emitting light in various forms to the cover glass and acquiring an image of the cover glass.

### CROSS-REFERENCE TO RELATED APPLICATIONS

This application claims the benefit of Korean Patent Application No. 10-2017-0048705, filed on Apr. 14, 2017 and Korean Patent Application No. 10-2018-0043160, filed on Apr. 13, 2018, in the Korean Intellectual Property Office, the disclosure of which is incorporated herein in its entirety by reference.

### BACKGROUND ART

Cover glass for protecting displays is used in display apparatuses such as liquid crystal display (LCD) displays or organic light-emitting diode (OLED) displays. In general, the cover glass is manufactured through a melting manufacturing process and the final cover glass undergoes an inspection process to detect the presence of fine scratches or foreign materials thereon.

Recently, interest in portable digital devices such as smartphones or table PCs requiring compact displays has increased. Due to the explosive use of portable digital devices, interest in cover glass inspection processes and apparatuses has also increased.

In particular, in the case of portable digital devices, since the distance between the eyes of a user and the portal digital device is very small, the presence of defects in a cover glass directly affects the quality of the portal digital device, and thus, a process of analyzing defects becomes more important.

In the process of analyzing defects of a cover glass, inspection of the cover glass to detect defects is conducted before and after reinforced coating on the cover glass. Regarding an inspection apparatus according to the related art, when a surface of a cover glass is inspected to detect stains or scratches thereon, inspection results may subjectively vary according to observers.

For example, in the related art, when a glass substrate is inspected with respect to waveness, after the cover substrate is placed perpendicularly to a traveling direction of light for inspection, the cover glass is tilted so that a shadow of the cover substrate occurs on a screen located on a path along which the light that passed through the cover glass travels.

The shadow projected to the screen may include a curved portion that appears to be brighter or darker than a peripheral portion due to a difference in transmittance or phase of light generated between a portion having a defect and a portion having no defect. This difference may be referred to as waveness. According to the related art, defect inspection is performed by determining with the naked eye whether waveness is generated.

However, this inspection is time consuming, inspection of the entire glass substrate is not possible, and inspection results are subjective according to the person conducting the inspection, and thus, reliability of the defect inspection is low. Furthermore, it is difficult to identify the surfaces of the cover glass where a defect is located, and it is impossible to precisely identify a defect in the cover glass.

In addition, recently, a cover glass having a curved edge portion along a surface of the cover glass or a curved protruding edge portion along opposite lateral sides of a surface of the cover glass has been manufactured. However, the existing equipment cannot be used to perform total inspection of such a cover glass having an edge portion, and thus, development of appropriate technology in this regard is urgently needed.

### DISCLOSURE OF INVENTION

### Solution to Problem

According to an embodiment of the inventive concept, a cover glass inspecting apparatus may include a transfer module for transferring a cover glass, the cover glass may include a flat plate portion extending in first and second directions crossing with each other and edge portions protruding in a third direction perpendicular to the first and second directions and connected to outer circumference of the flat plate portion wherein the flat porting includes first and second surfaces facing each other. The cover glass inspecting apparatus may further include first optical module for photographing the first surface, a second optical module for photographing the second surface and a control module for reading images of the cover glass taken by the first optical module and the second optical module. The first optical module may include a first sub optical module for photographing the first surface, and a second sub optical module for photographing the edge portions.

The edge portions include first edges extending in the first direction and second edges extending in the second direction, wherein the transfer module transfers the cover glass in the first direction, and the second sub optical module photographs the first edge portions.

A length of the first edge portions in the first direction is greater than a length of the second edge portions in the second direction.

The first sub optical module may include at least one of a transmission light source, a scattering transmission light source, a reflection light source, and a diffusion light source, and a first optical system for photographing the first surface.

The second sub optical module may include includes at least one of a transmission light source, a scattering transmission light source, and a second optical system which is different from the first optical system and photographs the first edge portions.

A depth of field of the second optical system is greater than a depth of field of the first optical system.

The second optical systems may include a plurality of second optical systems.

The first optical system is inclined in the first direction with respect to the third direction.

The second optical systems are inclined in the second direction with respect to the third direction.

The second optical systems are connected to a driving device configured to adjust a position and a tilt of the second optical systems.

The second optical module includes a third sub optical module for photographing the second surface, and a fourth sub optical module for photographing the second edge portions.

A photographing manner of the first to third sub optical modules is different from a photographing manner of the fourth sub optical module.

A photographing manner of the first to third sub optical modules is line scanning, and a photographing manner of the fourth sub optical module is shot photographing.

The first sub optical module may include a first reflection light source arranged at a distance from the first surface, the first reflection light source irradiating light to be reflected on the first surface in a direction tilted with respect to the third direction, a first transmission light source arranged at a distance from the second surface and irradiating light to be transmitted through the second surface in a tilted direction with respect to the third direction, and a first scattering transmission light sources arranged in a plurality of rows between the first transmission light source and the transport module for irradiating light to be scattered by the second surface and transmitted through the second surface.

The third sub optical module may includes a second reflection light source arranged at a distance from the surface, the second reflection light source irradiating light to be reflected on the second surface in a direction tilted with respect to the third direction, a second transmission light source arranged at a distance from the first surface and irradiating light to be transmitted through the first surface in a tilted direction with respect to the third direction, and a second scattering transmission light sources arranged in a plurality of rows between the second transmission light source and the transport module for irradiating light to be scattered by the first surface and transmitted through the first surface.

The second sub optical module may includes a first edge portion transmission light source arranged at a distance from the first edge portions and irradiating light to be transmitted through the first edge portions of the cover glass.

The fourth sub optical module may include a second edge portion transmission light source arranged at a distance from the second edge portions and irradiating light to be transmitted through the second edge portions of the cover glass.

According to an embodiment of the inventive concept, a cover glass inspecting apparatus may include a transfer module for transferring a cover glass including a flat plate portion including a first surface and a second surface facing each other and a protruding portion protruding from a central portion of the second surface, a first optical module including a first transmission light source, a first reflection light source, and a first scattering light source, the first optical module photographing the protruding portion, a second optical module including a second transmission light source, a second reflection light source, and a second scattering light source, the second optical module photographing the first surface, a third optical module including a plurality of third scattering light sources, the third optical module photographing the second surface, and a control module for reading images of the cover glass photographed by the first to third optical modules.

The plurality of third scattering light sources are arranged along an outer circumference of the second surface.

The first surface and the second surface are rectangular, the protruding portion is rectangular parallelepiped, and the plurality of third scattering light sources are arranged in two or four rows along the outer circumference of the second surface.

The first surface and the second surface are circular and have a first circumference, the protruding portion is cylindrical and has a second circumference less than the first circumference, and the plurality of third scattering light sources are arranged along a virtual circular circumference.

According to an embodiment of the inventive concept, a method of manufacturing cover glass may include supplying a cover glass to an inspection module, performing a first inspection on the cover glass, cleaning the cover glass on which the first inspection was performed, performing a second inspection on the cleaned cover glass, performing at least one of shaping, polishing, chamfering, and coating on the cover glass on which the second inspection was performed, and performing a third inspection on the processed cover glass wherein the cover glass includes a flat plate portion and a protruding portion protruding from the flat plate portion, wherein each of the first to third inspections includes inspecting the flat plate portion and the protruding portion.

Inspecting the flat portion includes inspecting the flat portion by a Schlieren method using at least one of transmission illumination, reflection illumination, and scattering illumination.

Inspecting the protruding portion includes inspecting the protruding portion by a Schlieren method using at least one of transmission illumination, and scattering illumination.

### Advantageous Effects of Invention

The inventive concept provides a cover glass inspection apparatus which may inspect a cover glass for defects during transfer of the cover glass, thereby reducing a process time.

The inventive concept further provides a cover glass inspection apparatus which may detect a position, size, and formation scope of a defect on a cover glass, thereby improving reliability of inspection results.

The inventive concept further provides a cover glass inspection apparatus which may be capable of performing a total inspection of a cover glass having an edge portion along a surface or opposite lateral sides of a surface of the cover glass.

The inventive concept further provides a cover glass inspection apparatus which may provides information about a defect identified on a cover glass to a user's terminal.

### BRIEF DESCRIPTION OF DRAWINGS

Embodiments of the inventive concept will be more clearly understood from the following detailed description taken in conjunction with the accompanying drawings in which:

FIG. 1 is a schematic conceptual diagram of a configuration of a cover glass inspection apparatus according to an embodiment;

FIG. 2 is a schematic side view of a cover glass inspection apparatus according to an embodiment;

FIG. 3 is a schematic front sectional view of a cover glass inspection apparatus according to an embodiment;

FIG. 4 is a schematic plan view of a diffuse light source according to an embodiment.

FIG. 5 is a schematic side view of a cover glass inspection apparatus according to another embodiment;

FIG. 6 is a schematic side view of a cover glass inspection apparatus according to another embodiment;

FIG. 7 is a front sectional view of a cover glass inspection apparatus according to another embodiment.

FIG. 8 is a conceptual diagram for explaining cover glass inspection apparatuses according to some embodiments.

FIGS. 9A and 9B are side views schematically showing a cover glass inspection apparatus according to some embodiments.

FIG. 10 is a front sectional view schematically showing a cover glass inspection apparatus according to some embodiments.

FIGS. 11A and 11B are schematic perspective views of a configuration of the cover glass.

FIGS. 12A to 12D are schematic views of a depressed portion scattering light source.

FIG. 13 is a schematic block diagram for explaining a cover glass manufacturing apparatus according to some embodiments.

FIG. 14 is a flowchart for explaining a method of manufacturing a cover glass according to some embodiments.

### BEST MODE FOR CARRYING OUT THE INVENTION

The present disclosure will now be described more fully with reference to the accompanying drawings, in which embodiments of the disclosure are shown. Throughout the drawings, like reference numerals denote like elements. In the following description, when detailed descriptions about related well-known functions or structures are determined to make the gist of the present disclosure unclear, the detailed descriptions will be omitted herein.

In the present specification, terms such as “first”, “second”, “A”, “B”, “(a)”, and “(b)” are used merely to describe a variety of members, parts, areas, layers, and/or portions, but the constituent elements are not limited by the terms. In the present specification, when a constituent element is described to be “connected to”, “coupled with/to” or “accessed to” to another constituent element, the constituent element is directly, or through at least one of other constituent elements, connected to or accessed to another constituent element.

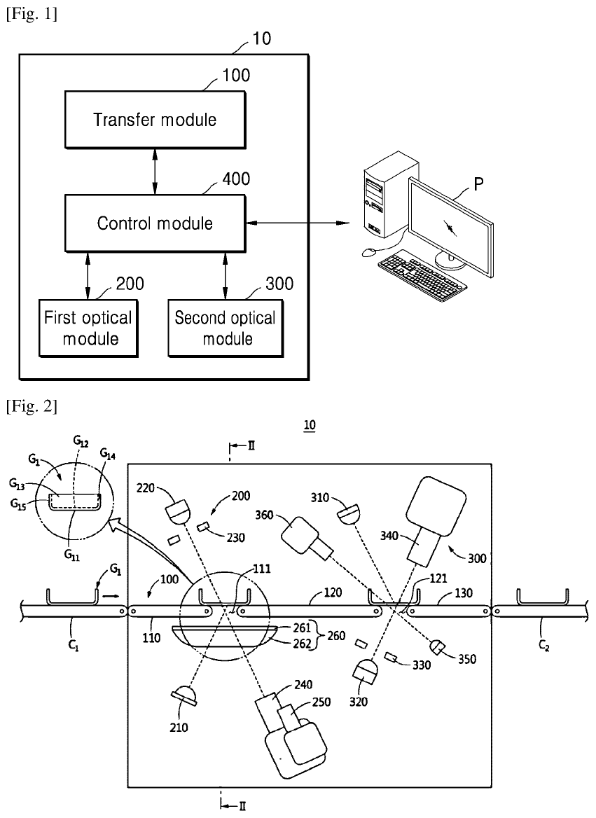

Referring to FIG. 1, a cover glass inspection apparatus 10 may include a transfer module 100, a first optical module 200, a second optical module 300, and a control module 400.

The transfer module 100 may be a belt conveyor, a roller conveyor, an air conveyor, a linear motor, a transfer robot, or any other conveyor or robot which is widely used in the industry. The transfer module 100 may transfer a cover glass parallel to a horizontal direction. In some embodiments, when a belt conveyor is used, a material of a belt may be polyurethane, which does not cause damage or contamination when contacting a glass sample. Particular, in some embodiments, when an air conveyor is used, since physical friction decreases, glass damages may be prevented from occurring during the transfer of the cover glass, and due to an effect of air injection, foreign materials adhering to the cover glass may be removed. In some embodiments, when a linear motor is used as the transfer module 100, a transfer speed may be fast and stability may be high compared to the conveyor belt.

In some embodiments, the first optical module 200 may emit at least one of light passing through one surface of the cover glass, light scattered by one surface of the cover glass and passing through one surface, light reflected by one surface of the cover glass, light scattered by one surface of the cover glass and reflected by one surface of the cover glass, and diffuse light, and capture at least one of a transmission image, a reflection image, and a scattering image formed on one surface of the cover glass. The first optical module 200 may transmit the captured images of the cover glass to the control module 400.

The second optical module 300 may be spaced apart from the first optical module 200 by a certain interval. The second optical module 300 may emit at least one of light passing through the other surface of the cover glass, light scattered by the other surface of the cover glass and passing through the cover glass, light reflected by the cover glass, light scattered and reflected by the other surface of the cover glass, and diffuse light, and capture at least one of a transmission image, a reflection image, and a scattering image formed on the other surface of the cover glass. In some embodiments, the second optical module 300 may transmit the captured images of the cover glass to the control module 400.

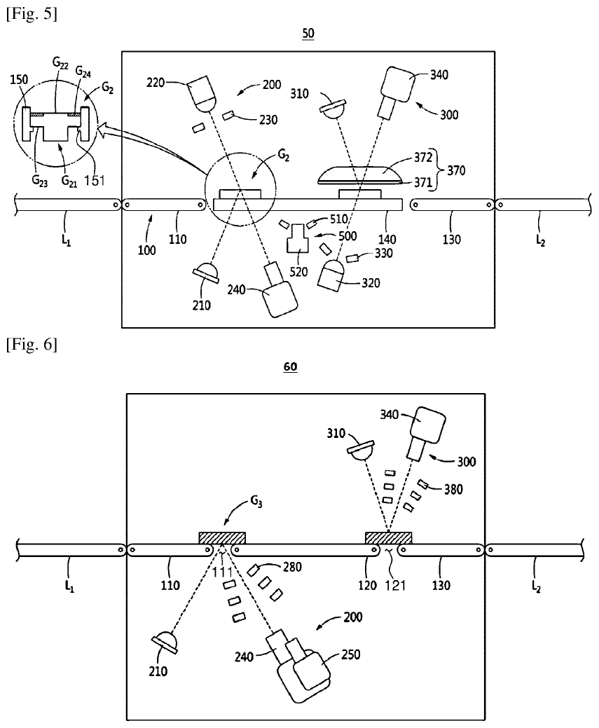

The cover glass inspection apparatus may further include a third optical module according to the shape of a cover glass, which is described below with reference to FIG. 5.

In some embodiments, the first optical module 200 and the second optical module 300 may emit at least two of transmission light, scattering transmission light, reflection light, scattering reflection light, and diffuse light to the cover glass according to a material, shape, and transparency of the cover glass, and obtain at least two of a transmission image, a reflection image, a scattering image, and a diffuse image. In some embodiments, the first optical module 200 and/or the second optical module 300 may capture an image of the cover glass formed by the transmission light or the reflection light by a Schlieren method.

The Schlieren method is an optical method in which, when a transparent medium includes a portion where a refractive index slightly changes, the shape of an object that causes the refractive index change is observed by using a change in the travelling direction of light. A refractive index of a portion of the cover glass where a defect is formed may be changed due to the defect. Accordingly, light in a portion of a captured image corresponding to the defect is scattered to be darker than a peripheral portion. Thus, the first optical module 200 and/or the second optical module 300 may inspect whether a defect exists on the cover glass and characteristics of the defect through detection of a change in brightness.

The control module 400 may include a microprocessor and may communicate with the transfer module 100, the first optical module 200, and the second optical module 300 to control these constituent elements. In some embodiments, the control module 400 may be a controller, a microprocessor, a processor including a more complicated structure such as CPU or GPU, a processor configured by software, or dedicated hardware or firmware. In some embodiments, the control module 400 may be a general use computer, a digital signal processor (DSP), a field programmable gate array (PPGA), and dedicated hardware such as an application specific integrated circuit (ASIC). In some embodiments, the control module 400 may sequentially drive the light sources according to the inspection speed of the cover glass to control an image capturing timing, and may detect the existence of a defect by analyzing the captured image. In some embodiments, the control module 400 may read out the captured image, detect a defect by obtaining at least one of pieces of information about a cover glass size, a defect type, a defect size, a defect formation surface, a defect position on the defect formation surface, and a congregation phase of defects, and store, in a user terminal P, an electronic file of an image of a cover glass, in which the position of a defect is converted into coordinates.

The user terminal P may be a computing device such as a workstation computer, a desktop computer, a laptop computer, or a tablet computer.

A configuration of a cover glass inspection apparatus according to an embodiment is described with reference to FIGS. 2 to 4.

FIG. 2 is a schematic side view of cover glass inspection apparatus according to an embodiment.

Referring to FIG. 2, the cover glass inspection apparatus 10 may include the transfer module 100, the first optical module 200, the second optical module 300, and the control module 400.

A cover glass G₁ may have a flat rectangular shape or include an edge portion protruding vertically along an edge of one surface of the flat rectangular shape. For convenience of explanation, a flat surface of the cover glass G₁ may be referred to as a lower surface portion G₁₁, and a surface where the edge portion is formed may be referred to as an upper surface portion G₁₂. Of the protruding edge portion, a surface that is parallel to a transfer direction may be referred to as side edge portions G₁₃, an edge portion protruding at a front side in the transfer direction may be referred to as a front edge portion G₁₄, and an edge portion protruding at a rear side in the transfer direction may be referred to as a rear edge portion G₁₅. The cover glass G₁ may include a transparent material.

Although in FIG. 2 the cover glass G₁ is illustrated to have a flat rectangular shape and an edge portion protruding at a certain interval along an edge of the flat rectangular shape, the present disclosure is not limited thereto. In some embodiments, the edge portion may include a pair of edges facing each other of the upper surface portion G₁₂.

The transfer module 100 that supports and transfers the lower surface portion G₁₁ of the cover glass G₁ may be a conveyor belt, and may include a first conveyor 110, a second conveyor 120, and the third conveyor 130.

In some embodiments, the transfer lengths of the first, second, and third conveyors 110, 120, and 130 may be from about 150 mm to about 250 mm. In some embodiments, the first, second, and third conveyors 110, 120, and 130 may be arranged spaced apart at an interval of about 30 mm to about 50 mm in the transfer direction. In some embodiments, when the cover glass G₁ passes over an interval formed by the first, second, and third conveyors 110, 120, and 130, an image of the cover glass G₁ is captured by emitting reflection light, transmission light, and scattering light. In some embodiments, when an interval between the first and second conveyors 110 and 120, and/or an interval between the second and third conveyors 120 and 130, is less than about 30 mm, it may be difficult to capture an image of the cover glass G₁. When the interval exceeds about 50 mm, the cover glass G₁ may not be transferred and may fall from the first and second conveyors 110 and 120. In some embodiments, the certain interval respectively between the first, second, and third conveyors 110, 120, and 130 may be about 40 mm, but the present disclosure is not limited thereto. The interval between the first and second conveyors 110 and 120 and/or an interval between the second and third conveyors 120 and 130 may be variously adjusted according to a size and other characteristics of the cover glass G₁ to be inspected.

In the following description, the certain interval formed by the first conveyor 110 and the second conveyor 120 is referred to as a first lighting hole 111, and the certain interval formed by the second conveyor 120 and the third conveyor 130 may be referred to as a second lighting hole 121.

The cover glass G₁ may be loaded on the first conveyor 110 via a load conveyor C1 arranged in front of the first conveyor 110. The cover glass G₁, of which inspection was completed, is transferred to an unload conveyor C2 via the third conveyor 130 and may be unloaded.

The first optical module 200 may include a first reflection light source 210, a first transmission light source 220, a first scattering transmission light source 230, a first optical system 240, and a side optical system 250.

The first reflection light source 210 may emit light that is reflected from a surface of the cover glass G₁ to one surface of the cover glass G₁. In some embodiments, the first reflection light source 210 may emit reflection light to the lower surface portion G₁₁ of the cover glass G₁ located at the first lighting hole 111. The first reflection light source 210 may be arranged under the transfer module 100 to be tilted by a certain angle with respect to the transfer module 100. The first reflection light source 210 may include a slit or a concave lens to allow light to be irradiated only to the lower surface portion G₁₁ of the cover glass G₁ located at the first lighting hole 111. The first optical system 240 may capture an image of the lower surface portion G₁₁ of the cover glass G₁ by using the light emitted by the first reflection light source 210 and reflected by the cover glass G₁. In some embodiments, the first reflection light source 210 may be a linear light source extending in a direction perpendicular to the direction in which the cover glass G₁ is transferred. In some embodiments, the first reflection light source 210 may include a plurality of light-emitting diodes arranged in the direction perpendicular to the direction in which the cover glass G₁ is transferred.

The first transmission light source 220 may emit transmission light to the other surface of the cover glass G₁. In some embodiments, the first transmission light source 220 may emit light to the upper surface portion G₁₂ of the cover glass G₁ located at the first lighting hole 111. The first transmission light source 220 may be arranged above the transfer module 100 to be tilted by a certain angle with respect to the transfer module 100. Since the first transmission light source 220 may be tilted, a change in the refractive index generated due to a defect of the cover glass G₁ with respect to the transmission light may be increased. In some embodiments, the first transmission light source 220 may be a linear light source extending in the direction perpendicular to the direction in which the cover glass G₁ is transferred. In some embodiments, the first transmission light source 220 may include a plurality of light-emitting diodes arranged in the direction perpendicular to the direction in which the cover glass G₁ is transferred. In some embodiments, the light-emitting diodes arranged at both ends of the first transmission light source 220 may be aligned to face the side optical system 250 that is described later.

In some embodiments, to allow the first optical system 240 to capture an image of the lower surface portion G₁₁ of the cover glass G₁ by the light transmitting through the cover glass G₁, the first transmission light source 220 may be arranged symmetrically to the first reflection light source 210 with respect to the transfer module 100. In some embodiments, the first transmission light source 220 may include a slit or a concave lens to allow light to be irradiated only to the upper surface portion G₁₂ of the cover glass G₁ located at the first lighting hole 111.

The first scattering transmission light source 230 may emit light scattered by the upper surface portion G₁₂ of the cover glass G₁, and transmitting through the upper surface portion G₁₂. In some embodiments, the first scattering transmission light source 230 may be arranged at a position not blocking the light emitted by the first transmission light source 220. In some embodiments, the first scattering transmission light source 230 may be arranged between the first transmission light source 220 and the first conveyor 110. In some embodiments, the first scattering transmission light source 230 may include a plurality of first scattering transmission light sources arranged around a direction in which the light emitted by the first transmission light source 220. In some embodiments, the first scattering transmission light source 230 may be arranged in four rows or two rows.

In some embodiments, the first optical system 240 may be aligned with lighting directions of the reflection light and the transmission light that are emitted to the one surface of the cover glass G₁. In some embodiments, the first optical system 240 may be arranged under the transfer module 100. In some embodiments, the first optical system 240 may capture an image of the one surface of the cover glass G₁. In some embodiments, the first optical system 240 may capture an image of the lower surface portion G₁₁ of the cover glass G₁ formed by the irradiation of light. The first optical system 240 may capture an image of the cover glass G₁ transferred between the first and second conveyors 110 and 120 in a line scanning method. The first optical system 240 may capture each of a reflection image by the first reflection light source 210, a transmission image by the first transmission light source 220, and a scattering image by the first scattering transmission light source 230. The first reflection light source 210, the first transmission light source 220, the first scattering transmission light source 230, and the first optical system 240 may constitute a first sub-optical module.

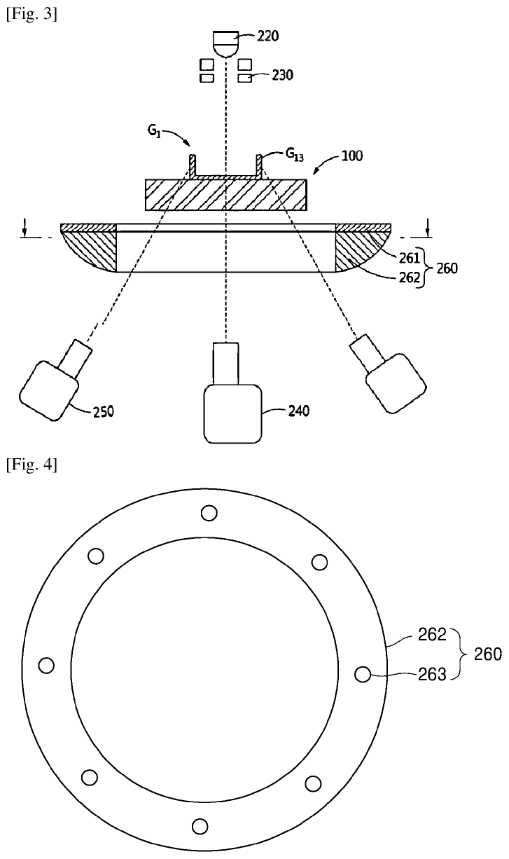

FIG. 3 is a schematic front sectional view of a cover glass inspection apparatus according to an embodiment.

Referring to FIGS. 2 and 3, the side optical system 250 may capture images of the side edge portions G₁₃. In some embodiments, the side optical system 250 may be arranged to be tilted in a direction perpendicular to the transfer module 100 with respect to the first optical system 240. The side optical system 250 may be spaced apart from the first optical system 240. The side optical system 250 may include a plurality of side optical systems symmetrically arranged with respect to the first optical system 240 under the transfer module 100. The side optical system 250 may capture images of the side edge portions G₁₃ by the light transmitting through the side edge portions G₁₃ and images of the side edge portion G₁₃ by the scattering light. The side optical system 250 and some of light sources, such as, the first transmission light source 220 and the first scattering transmission light source 230, may constitute a second sub-optical module.

In some embodiments, when a print surface where certain characters or designs are printed is formed on the cover glass G₁, a first diffuse light source 260 for emitting diffuse light to the print surface may be further be arranged. In some embodiments, when the print surface is formed on the lower surface portion G₁₁ of the cover glass G₁, the first diffuse light source 260 may be further provided under the transfer module 100. However, the present disclosure is not limited thereto, and the first diffuse light source 260 may be omitted.

FIG. 4 is a schematic plan view of a diffuse light source according to an embodiment.

Referring to FIG. 4, the first diffuse light source 260 may include a plurality of light-emitting diode (LED) lights 263 arranged in an LED light housing 262, and a diverging sheet 261 for diffusing light of the LED lights 263.

The first diffusion light source 260 may be disposed under the transfer module 100 to irradiate light to the first lighting hole 111. The first diffuse light source 260 has an approximately ring shape, in which a center portion is open at a certain interval and in a certain size, not to interfere with the light transmitting through the cover glass G₁.

Referring back to FIG. 2, when the cover glass G₁ transferred by the transfer module 100 passes over the first lighting hole 111, the cover glass G₁ may be irradiated with the lights emitted by the first reflection light source 210, the first transmission light source 220, the first scattering transmission light source 230, and the first diffuse light source 260. The first optical system 240 that may capture an image of one surface of the cover glass G₁ may sequentially capture a reflection image by the first reflection light source 210, a transmission image by the first transmission light source 220, a scattering image by the first scattering transmission light source 230, and a diffuse image by the first diffuse light source 260, which are formed on the one surface of the cover glass G₁.

In some embodiments, the first reflection light source 210, the first transmission light source 220, and the first scattering transmission light source 230 may be sequentially turned on. In some embodiments, the first reflection light source 210, the first transmission light source 220, and the first scattering transmission light source 230 may emit lights at different time points. In an embodiment, when the first reflection light source 210 is turned on, the first transmission light source 220 and the first scattering transmission light source 230 may be turned off, and thus the first optical system 240 may obtain an image reflected from the lower surface portion G₁₁. Likewise, when the first transmission light source 220 is turned on, the first reflection light source 210 and the first scattering transmission light source 230 may be turned off, and thus the first optical system 240 may obtain an image transmitting through the upper surface portion G₁₂ and the lower surface portion G₁₁. Likewise, when the first scattering transmission light source 230 is turned on, the first reflection light source 210 and the first transmission light source 220 are turned off, and thus the first optical system 240 may obtain an image scattered by the cover glass G₁ and transmitting through the upper surface portion G₁₂ and the lower surface portion G₁₁. Furthermore, the side optical system 250 may capture images of the side edge portions G₁₃ of the cover glass G₁.

In some embodiments, the side optical system 250 may have a depth of field greater than that of the first optical system 240. Accordingly, even when a portion where the side edge portions G₁₃ are connected to the lower surface portion G₁₁ and the upper surface portion G₁₂ has a large curvature, accurate images of the side edge portions G₁₃ may be obtained.

In some embodiments, the first optical module 200 including the first optical system 240 and the side optical system 250 may transmit the respective images to the control module 400. In some embodiments, the control module 400 may generate reflection, transmission, and scattering images of the entire lower surface portion G₁₁ by combining the line-scanned reflection, transmission, and scattering images of the first optical system 240. In some embodiments, the control module 400 may create transmission and scattering images of the entire side edge portions G₁₃ by combining the line-scanned transmission and scattering images of the side optical system 250.

The second optical module 300 may include a second reflection light source 310, a second transmission light source 320, a second scattering transmission light source 330, a second optical system 340, a third transmission light source 350, and an edge portion optical system 360.

The second reflection light source 310 may emit light that is reflected from a surface of the cover glass G₁ to the other surface of the cover glass G₁. In an embodiment, the second reflection light source 310 may emit reflection light to the upper surface portion G₁₂ of the cover glass G₁ located at the second lighting hole 121. The second reflection light source 310 may be arranged above the transfer module 100 to be tilted by a certain angle. The second reflection light source 310 may include a slit or a concave lens to allow light to be irradiated only to the upper surface portion G₁₂ of the cover glass G₁ located at the second lighting hole 121. The second optical system 340 may capture an image of the upper surface portion G₁₂ of the cover glass G₁ by the reflection light emitted by the second reflection light source 310. In some embodiments, the second reflection light source 310 may be a linear light source extending in the direction perpendicular to the direction in which the cover glass G₁ is transferred. In some embodiments, the second reflection light source 310 may include a plurality of light-emitting diodes arranged in the direction perpendicular to the direction in which the cover glass G₁ is transferred.

The second transmission light source 320 may emit transmission light to one surface of the cover glass G₁. In an embodiment, the second transmission light source 320 may emit light to the lower surface portion G₁₁ of the cover glass G₁ located at the second lighting hole 121. The second transmission light source 320 may be arranged under the transfer module 100 to be tilted by a certain angle. Since the second transmission light source 320 may be arranged to be tilted with respect to the lower surface portion G₁₁, a change in the refractive index generated due to a defect by the transmission light may be increased. In some embodiments, the second transmission light source 320 may be a linear light source extending in the direction perpendicular to the direction in which the cover glass G₁ is transferred. In some embodiments, the second transmission light source 320 may include a plurality of light-emitting diodes arranged in the direction perpendicular to the direction in which the cover glass G₁ is transferred.

Since the second optical system 340 may capture an image of the upper surface portion G₁₂ of the cover glass G₁ by the transmission light emitted from the second transmission light source 320 and transmitting through the cover glass G₁, the second transmission light source 320 may be arranged symmetrically with respect to the second reflection light source 310. The second transmission light source 320 may also include a slit or a concave lens to allow light to be irradiated only to the lower surface portion G₁₁ of the cover glass G₁ located at the second lighting hole 121.

The second scattering transmission light source 330 may emit light scattered by the one surface of the cover glass G₁ and transmitting through the one surface of the cover glass G₁. In an embodiment, the second scattering transmission light source 330 may be arranged not to cover the light of the second transmission light source 320. In some embodiments, the second scattering transmission light source 330 may be arranged between the second transmission light source 320 and the second conveyor 120. In some embodiments, the second scattering transmission light source 330 may include a plurality of second scattering transmission light sources arranged around a direction in which the light emitted by the second transmission light source 320. In some embodiments, the second scattering transmission light source 330 may be arranged in four rows or two rows.

In some embodiments, an operation method of the second reflection light source 310, the second transmission light source 320, and the second scattering transmission light source 330 may be substantially the same as that of the first reflection light source 210, the first transmission light source 220, and the first scattering transmission light source 230.

The second optical system 340 may be arranged above the transfer module 100 to be aligned with travelling directions of the reflection light and the transmission light that are emitted to the one surface of the cover glass G₁. The second optical system 340 may capture an image of the other surface of the cover glass G₁ formed by the irradiation of light. The second optical system 340 may capture each of a reflection image by the second reflection light source 310, a transmission image by the second transmission light source 320, and a scattering image by the second scattering transmission light source 330. In some embodiments, an image capturing method of the second optical system 340 may be substantially the same as that of the first optical system 240.

The third transmission light source 350 may emit transmission light to the front edge portion G₁₄ that protrudes at the front side in the transfer direction of the cover glass G₁. In some embodiments, the third transmission light source 350 may be arranged under the transfer module 100 to be tilted by a certain angle. In some embodiments, the third transmission light source 350 may be a surface light source.

The edge portion optical system 360 may capture an image formed as light is emitted to the front edge portion G₁₄ protruding at the front side in the transfer direction of the cover glass G₁. The edge portion optical system 360 may capture an image of the front edge portion G₁₄ by using the lights emitted by the third transmission light source 350 and the second scattering transmission light source 330. Accordingly, the image captured by the edge portion optical system 360 may include a transmission image by the light transmitting through the front edge portion G₁₄ and a scattering image by the light scattered by the front edge portion G₁₄. In some embodiments, an image capturing method of the edge portion optical system 360 may be different from those of the first and second optical systems 240 and 340 and the side optical system 250.

In some embodiments, the image capturing method of the edge portion optical system 360 may be a shot capturing method. In some embodiments, since the length of the front edge portion G₁₄ is less than those of the side edge portions G₁₃, an entire image of the front edge portion G₁₄ may be captured via the shot capturing method, not via the line scanning method.

Accuracy in measurement of the rear edge portion G₁₅ by the edge portion optical system 360 may deteriorate due to interference with the light emitted by the second transmission light source 320. In some embodiments, to prevent this interference, an image of the rear edge portion G₁₅ may be captured by using the second optical system 340. However, the present disclosure is not limited thereto. While the third transmission light source 350 operates (ON) and the second reflection light source 310, the second transmission light source 320, and the third second scattering transmission light source 330 do not operate (OFF), an image of the rear edge portion G₁₅ may be captured by the edge portion optical system 360.

In some embodiments, the second optical system 340 may capture a transmission image, a reflection image, and a scattering image of the upper surface portion G₁₂ of the cover glass G₁. In some embodiments, the second optical system 340 may capture a transmission image, a reflection image, and a scattering image of the rear edge portion G₁₅ of the cover glass G₁. In some embodiments, the edge portion optical system 360 may capture a transmission image and a scattering image of the front edge portion G₁₄ and/or the rear edge portion G₁₅ of the cover glass G₁. In some embodiments, the second optical module 300 may transmit the respective images to the control module 400. In some embodiments, the control module 400 may detect a defect by combining the image captured by the first optical module 200 and the image captured by the second optical module 300.

In some embodiments, the defect detected by the control module 400 may be any one of dents, scratches, particles and fibers, white dots, stains, edge defects, chippings, pinholes, moldings, and printing defects.

In a reflection image and a transmission image, the defect detected by the control module 400 may include all types of defects that may be generated in the cover glass G₁ including the above-mentioned defects. In a scattering transmission image, floating foreign materials smaller than resolutions of the first and second optical systems 240 and 340, the side optical system 250, and the edge portion optical system 360 may be inspected. When cover glass inspection apparatus 10 includes a second diffuse light source 370, the first and second optical systems 240 and 340 may inspect a defect on a printing surface.

In some embodiments, the control module 400 may detect the occurrence of a defect and the characteristics of a defect by selecting some of a reflection image, a transmission image, and a scattering image according to the type of a defect to be detected. In some embodiments, when the occurrence of a defect and the characteristics of a defect, such as dents, particles and fibers, or white dots, in the lower surface portion G₁₁ and the upper surface portion G₁₂ are to be detected, the control module 400 may use a reflection image and a transmission image. In some embodiments, when the occurrence of a defect and the characteristics of a defect, such as chipping, stain, and printing defect, in the lower surface portion G₁₁ and the upper surface portion G₁₂, are to be detected, the control module 400 may use a reflection image. In some embodiments, when the occurrence of a printing defect and the characteristics of a defect that is difficult to be detected from the reflection images of the lower surface portion G₁₁ and the upper surface portion G₁₂ are to be detected, the control module 400 may use a transmission image. In some embodiments, when the occurrence of a defect and the characteristics of a defect such as scratches in the lower surface portion G₁₁ and the upper surface portion G₁₂ are to be detected, the control module 400 may use a reflection image and a scattering image.

In some embodiments, when the occurrence of a defect and the characteristics of a defect, such as dents, chippings, stains, or printing defects, in the side edge portions G₁₃, the front edge portion G₁₄, and the rear edge portion G₁₅ are to be detected, the control module 400 may use a transmission image. In some embodiments, when a defect such as particles, fibers, and scratches, in the side edge portions G₁₃, the front edge portion G₁₄ and the rear edge portion G₁₅ are to be detected, the control module 400 may use a transmission image and a scattering image.

In some embodiments, the control module 400 may measure a size of a defect formed in the cover glass G₁ by obtaining an image by the transmission light. In some embodiments, since the characteristics of a defect clearly appear in the transmission image, the control module 400 may classify defects using the transmission image. In some embodiments, the control module 400 may detect a surface where a defect is located by using the reflection image, and then convert the position of the defect formed in the cover glass G₁ into coordinates. In some embodiments, the control module 400 may detect a size of a defect and a scope of an area where defects are located, by obtaining a scattering image.

In some embodiments, the control module 400 may measure the size of a defect by comparing the transmission image and the reflection image.

In some embodiments, the control module 400 may detect whether a defect is located on a surface of or inside the cover glass G₁ by comparing the transmission image or the reflection image with the scattering image. In an embodiment, the control module 400 may determine that a defect is formed inside the cover glass G₁ when the defect appears in the transmission image or the reflection image, but not in the scattering image. In another embodiment, the control module 400 may determine that a defect is formed on the surface of the cover glass G₁ when the defect appears commonly in the transmission image and the scattering image, or commonly in the reflection image and the scattering image. In some embodiments, the control module 400 may detect a defect on the print surface captured by diffuse light.

The control module 400 may combine the captured images and store the received reflection image, transmission image, and scattering image in a user terminal P in the form of an electronic file. In some embodiments, the control module 400 may process the reflection image, the transmission image, and the scattering image of the front edge portion G₁₄ of the cover glass G₁ from those of the other areas. In some embodiments, the control module 400 may measure and store the characteristics of a defect and the size of a defect from the transmission image. In some embodiments, in the scattering image, floating foreign materials that are smaller than a resolution of an optical system are scattered and detected to have a size greater than the original size thereof. In some embodiments, the control module 400 may perform regression analysis on the scattering image to correct an error in the size measurement. In some embodiments, the control module 400 may detect the size of a defect from the reflection image. The control module 400 may convert the position of a defect into coordinates by using information about the classification, position, or size of a defect, and may store the coordinates in the user terminal P.

Since the image by transmission light is an image captured while the transmission light penetrates through the cover glass G₁, a defect of an entire area of an irradiation surface and a captured surface may be detected. In the image by reflection light, a defect of a surface where light is reflected may be detected. Furthermore, since light is scattered by a defect formed on a surface being captured, the existence of a defect on a surface may be effectively detected.

FIG. 5 illustrates a cover glass inspection apparatus according to another embodiment. Compared to the previous embodiment, in the embodiment of FIG. 5, a center portion of a cover glass has a protruding shape, a transfer robot is provided as the second conveyor, and the third optical module for capturing an image of a depressed portion of the cover glass is further provided. Thus, differences with respect to the previous embodiment are mainly described below, and like descriptions and like reference numerals are used for the same elements.

Referring to FIG. 5, an apparatus 50 for inspecting a cover glass according may include the transfer module 100, the first optical module 200, the second optical module 300, the third optical module 500, and the control module 400.

The transfer module 100 may transfer a cover glass G₂ parallel to a horizontal direction. The transfer module 100 may include a first conveyor 110, the transfer robot 140, and a third conveyor 130.

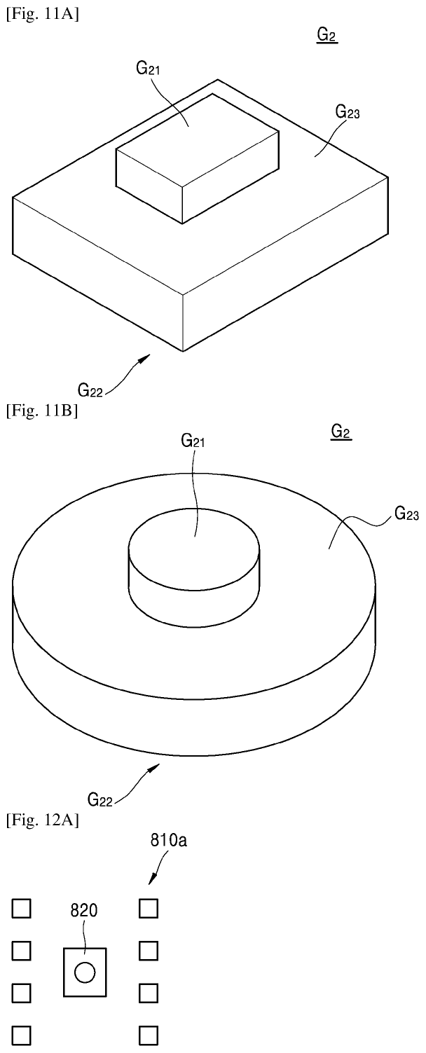

FIGS. 11A and 11B are schematic perspective views of a configuration of the cover glass G₂.

Referring to FIG. 11A, the cover glass G₂ may have a shape including a cuboid protruding from a center portion of a flat panel having a cuboidal shape. However, the present disclosure is not limited thereto, and as illustrated in FIG. 11B, the cover glass G₂ may have a shape including a circular cylinder protruding from a center portion of a circular cylinder. The cover glass G₂ in an upside-down state may be transferred by the transfer module 100. Accordingly, for convenience of explanation, a support surface of the protruding portion is referred to as a lower surface portion G₂₁, a surface formed at both sides of the protruding portion is referred to as a depressed portion G₂₃, and a surface opposite the support surface of the protruding portion is referred to as an upper surface portion G₂₂. A plurality of print surfaces G₂₄ where a bezel is printed may be formed in the upper surface portion G₂₂ of the cover glass G₂ at a position opposite to the depressed portion G₂₃.

The first conveyor 110 and the third conveyor 130 may be substantially the same as the first conveyor 110 and the third conveyor 130, respectively, described with reference to FIG. 2.

The transfer robot 140 may transfer the cover glass G₂ by supporting the depressed portion G₂₃ of the cover glass G₂. In an embodiment, the transfer robot 140 may include a support protruding portion 151 inwardly protruding from a support part 150, and transfer the cover glass G₂ by supporting the depressed portion G₂₃ at both sides thereof or at three different points thereof. In some embodiments, the support part 150 of the transfer robot 140 may be driven by a driving unit using generally used motor and gear.

In some embodiments, the transfer robot 140 may include a tray on which a plurality of cover glasses may be mounted in rows and columns. The tray may include a plurality of support parts that expose most of the cover glass G₂ and transfer the cover glasses G₂ at the same time. For efficient inspection of a defect, the transfer robot 140 may reduce the area of the cover glass G₂ covered by being supported by the support part 150. In an embodiment, when the support protruding portion 151 supports the cover glass G₂ in a three-point support method, most of the cover glass G₂ may be exposed (in an embodiment, about 98% or more).

The first optical module 200 may include the first reflection light source 210, the first transmission light source 220, the first scattering transmission light source 230, and the first optical system 240. The first reflection light source 210, the first transmission light source 220, the first scattering transmission light source 230, and the first optical system 240 may be substantially the same as those described with reference to FIGS. 2 and 3.

In some embodiments, in the first optical module 200, since the print surfaces G₂₄ of the cover glass G₂ is disposed in an upper portion thereof, a diffuse light source may not be provided under the transfer robot 140. The second optical module 300 may include the second diffuse light source 370, and the second diffuse light source 370 may be provided above the transfer robot 140. However, the present disclosure is not limited thereto, and the first optical module 200 may include a diffuse light source.

The second optical module 300 may include the second reflection light source 310, the second transmission light source 320, the second scattering transmission light source 330, the second diffuse light source 370, and the second optical system 340. In some embodiment, the second reflection light source 310, the second transmission light source 320, the second scattering transmission light source 330, and the second optical system 340 may be substantially the same as those described with reference to FIGS. 2 and 3.

The second diffuse light source 370 may include a housing 371 in which a plurality of LEDs are arranged and a diverging sheet 372 formed on a light-emitting surface and uniformly diffusing LED light. In some embodiments, the second diffuse light source 370 may be provided above the transfer robot 140 because the print surfaces G₂₄ of the cover glass G₂ is located on the upper surface portion G₂₂. In some embodiments, the second diffuse light source 370 may have a ring shape in which a center portion is open by a certain dimension, not to interfere with the transmission light.

The cover glass inspection apparatus 50 according to some embodiments may include the third optical module 500 between the first optical module 200 and the second optical module 300. However, the arrangement of the first to third optical modules 200, 300, and 500 is not limited thereto. In an embodiment, the first to third optical modules 200, 300, and 500 may be arranged in a certain permutation along the travelling direction of the cover glass G₂.

The third optical module 500 may be arranged to obtain an image of the depressed portion G₂₃ of the cover glass G₂. The third optical module 500 may be arranged vertically under the transfer robot 140 and may capture an image of the depressed portion G₂₃. The third optical module 500 may include a depressed portion scattering reflection light source 510 and a depressed portion optical system 520.

The depressed portion scattering reflection light source 510 may be arranged under the transfer robot 140 and may emit scattering reflection light to a lower surface of the cover glass G₂. The depressed portion scattering reflection light source 510 may be uniformly arranged in two or four rows to surround an image capturing direction of the depressed portion optical system 520 and not to interfere with the image capturing of the depressed portion optical system 520. However, the present disclosure is not limited thereto, and the depressed portion scattering reflection light source 510 may be provided in a manner of approximately circularly surrounding the depressed portion optical system 520.

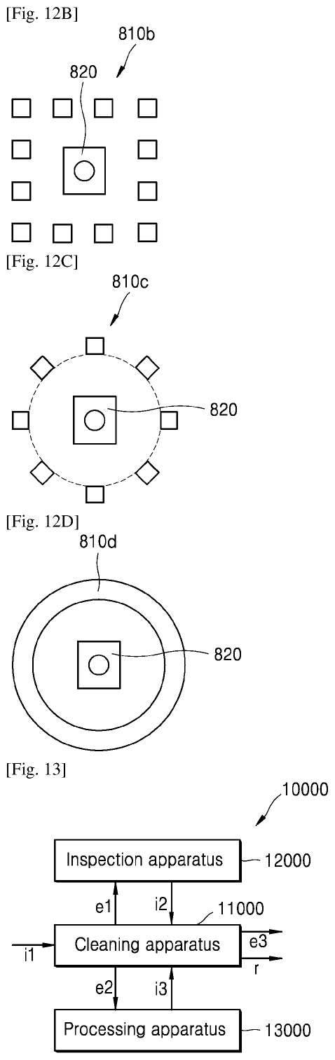

The depressed portion scattering reflection light source 510 is described in detail with reference to FIGS. 12A to 12D.

FIGS. 12A to 12D are schematic views of a depressed portion scattering light source.

Referring to FIGS. 12A and 12B, depressed portion scattering light sources 810a and 810b are arranged in two rows or four rows, corresponding to the cover glass of FIG. 11A. FIGS. 12C and 12D illustrate depressed portion scattering light sources 810C and 810D corresponding to the cover glass of FIG. 11B. Referring to FIG. 12C a plurality of depressed portion scattering light sources 810C may be arranged along a virtual circumference. Referring to FIG. 12D, the depressed portion scattering light source 810D has a ring shape.

The depressed portion optical system 520 may be arranged under the depressed portion scattering reflection light source 510, and may capture a scattering reflection image that is an image of the depressed portion G₂₃ of the cover glass G₂ to which light from the depressed portion scattering reflection light source 510 is emitted. A captured scattering reflection image may be transmitted to the control module 400.

The control module 400 may detect a defect from images respectively captured by the first optical module 200, the second optical module 300, and the third optical module 500, or a combined image thereof, and convert the position of the defect into coordinates and store the image in the user terminal P. The detect detection and storing methods of the control module 400 may be substantially the same as those described with reference to FIGS. 2 and 4.

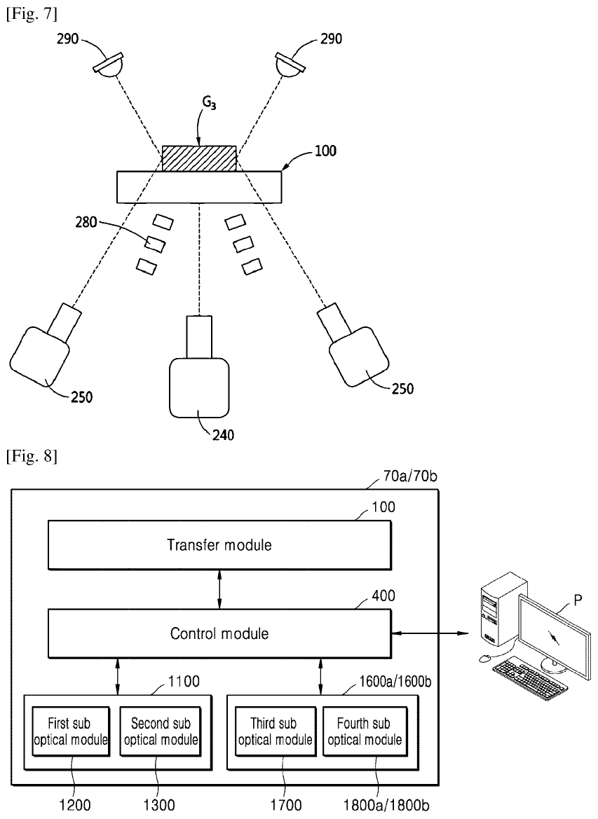

FIGS. 6 to 7 illustrate a cover glass inspection apparatus according to some embodiments. Compared to the above-described embodiments, in the present embodiments, the cover glass has a flat rectangular plate and is opaque, and thus, the cover glass inspection apparatus according to the present embodiments includes only a light source for emitting reflection light and a light source for emitting scattering reflection light, without a light source for emitting transmission light. Accordingly, differences from the above-described embodiments are mainly described, and like descriptions and like reference numerals are used for the same elements.

FIG. 6 is a schematic side view of a cover glass inspection apparatus according to another embodiment. FIG. 7 is a front sectional view of a cover glass inspection apparatus according to another embodiment.

Referring to FIGS. 6 and 7, cover glass inspection apparatus 60 according to the present embodiment may include the transfer module 100, the first optical module 200, and the second optical module 300.

The cover glass G₃ may have a flat rectangular shape. Furthermore, the cover glass G₃ may include an opaque material that does not transmit light.

The transfer module 100 may be substantially the same as that described with reference to FIG. 2.

The first optical module 200 may include the first reflection light source 210, the first optical system 240, a first scattering reflection light source 280, a side reflection light source 290, and the side optical systems 250.

The first reflection light source 210 and the first optical system 240 may be substantially the same as those described with reference to FIG. 2.

The first scattering reflection light source 280 may be arranged between the cover glass G₃ and the first optical system 240, and may emit scattering reflection light to one surface of the cover glass G₃. In some embodiments, the side reflection light source 290 may emit scattering reflection light to a lower surface of the cover glass G₃ located at the first lighting hole 111. The first scattering reflection light source 280 may be arranged in a plurality of rows, for example, in three or six rows, not to interfere with the image capturing image of the first optical system 240.

The side reflection light source 290 may be arranged above the first conveyor 110 to be tilted by a certain angle with respect to the transfer direction of the first conveyor 110. The side reflection light source 290 may include a plurality of side reflection light sources to emit reflection light to each side surface. The reflection light emitted by the side reflection light source 290 may be reflected from the cover glass G₃ and incident on the side optical system 250.

The side optical system 250 may capture an image of a side surface of the cover glass G₃ to which the reflection light is irradiated. The side optical system 250 may be arranged to be tilted by a certain angle with respect to the transfer direction of the first conveyor 110 such that the light emitted by the side reflection light source 290 may be reflected from the side surface of the cover glass G₃ to be incident thereon. The side optical system 250 may capture an image of the side surface of the cover glass G₃ to which the scattering reflection light emitted by the first scattering reflection light source 280.

The first optical module 200 may capture images of a lower surface and the side surface of the cover glass G₃ to which the reflection and scattering reflection lights are irradiated, and transmit the captured images to the control module 400.

The second optical module 300 may include the second reflection light source 310, the second optical system 340, and a second scattering reflection light source 380.

The second reflection light source 310 and the second optical system 340 may be substantially the same as those described with reference to FIG. 2.

The second scattering reflection light source 380 is arranged between the cover glass G₃ and the second optical system 340, and may emit scattering reflection light to the other surface of the cover glass G₃. For example, the second scattering reflection light source 380 may emit scattering reflection light to an upper surface of the cover glass G₃ located at the second lighting hole 121. The second scattering reflection light source 380 may be arranged in a plurality of rows, for example, in three rows, to surround the capturing direction of the second optical system 340 and not to interfere with the image capturing of the second optical system 340.

The second optical module 300 may transmit the captured image by the second optical system 340 to the control module 400.

The cover glass inspection apparatus 60 according to the present embodiment may detect a defect by capturing an image of the cover glass G₃ formed of an opaque material. Accordingly, the control module 400 may detect a defect from the captured image of the cover glass G₃ to which reflection or reflection scattering light is irradiated.

The control module 400 may measure a size of the cover glass G₃ from the image of the cover glass G₃ to which scattering reflection light is irradiated. Since the size of a defect in a scattering image may be incorrect, the control module 400 may measure the size of the cover glass G₃ through regression analysis. The control module 400 may classify defects through the image by reflection light, read out a surface where a defect is located, and convert the position of a defect formed in the cover glass G₃ into coordinates. The control module 400 may obtain a scattering image and detect the size of a defect and a scope of an area where defects are located. The control module 400 may detect a size of a defect by combining information about the size of a defect obtained through regression analysis and information about the size of a defect by reflection light.

Furthermore, the control module 400 may detect whether a defect is located on the surface of the cover glass G₃ or inside the cover glass G₃ by comparing the image captured by reflection light with the image captured by scattering light. In some embodiments, the control module 400 may determine that a defect is generated inside the cover glass G₃ when the defect detected from the image captured by reflection light does not appears in the image captured by scattering light, and that a defect is generated outside the cover glass G₃ when the defect detected from the image captured by reflection light also appears in the image captured by scattering light. The control module 400 may combine the captured images and store the images in the user terminal P. In this state, the control module 400 may convert the position of a defect into coordinates by using the classification, location, or size of the defect and store the coordinates in the user terminal P.

FIG. 8 is a conceptual diagram for explaining cover glass inspection apparatuses 70a and 70b according to some embodiments.

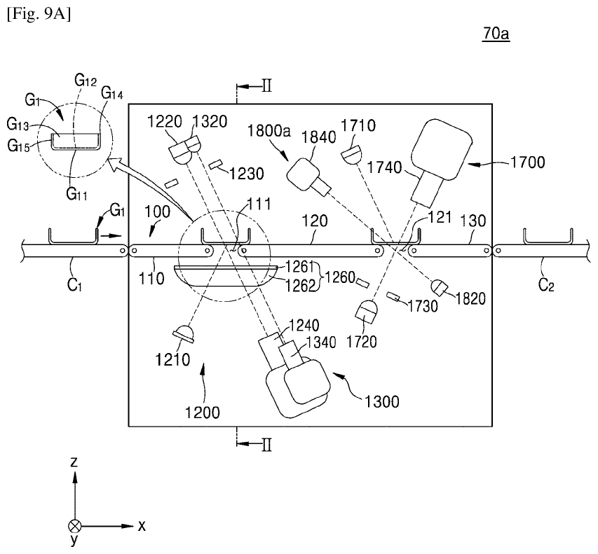

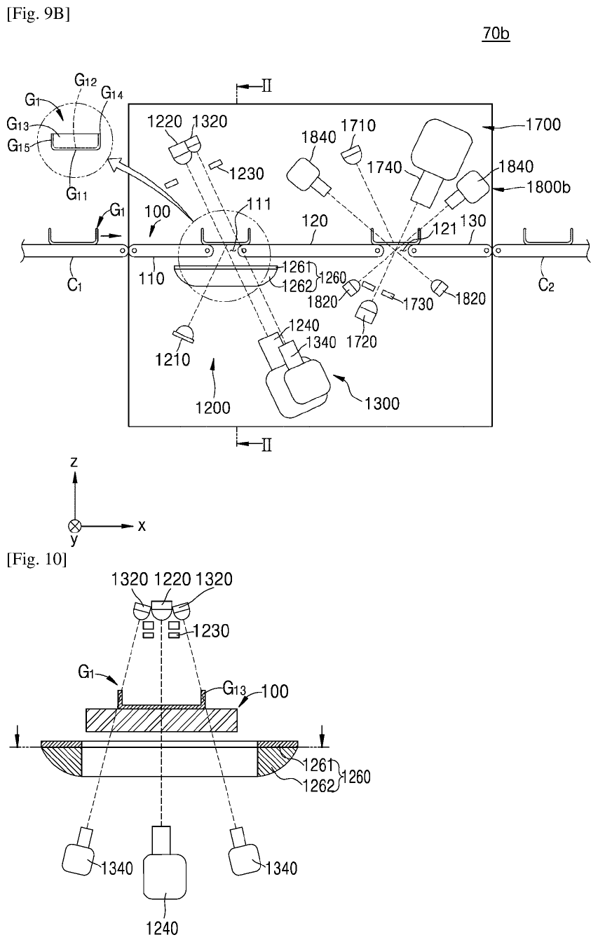

FIGS. 9A and 9B are side views schematically showing a cover glass inspection apparatus according to some embodiments.

FIG. 10 is a front sectional view schematically showing a cover glass inspection apparatus according to some embodiments.

The cover glass inspection apparatuses of FIGS. 8 to 10 will be described only with respect to differences with respect to FIGS. 1 to 4. Some of the descriptions presented with respect to FIGS. 1 to 4 are also valid for the cover glass inspection apparatuses of FIGS. 8 to 10.

According to some embodiments, each of the cover glass inspection apparatuses 70a/70b may include a first optical module 1100 and a second optical module 1600a/1600b.

According to some embodiments, the first optical module 1100 may include a first sub optical module 1200 and a second sub optical module 1300. The second optical module 1600a/1600b may include a third sub optical module 1700 and a fourth sub optical module 1800a/1800b.

The first sub optical module 1200 may include a first reflection light source 1210, a first transmission light source 1220, a first scattering transmission light source 1230, and a first optical system 1240. According to some embodiments, the first reflection light source 1210, the first scattering transmission light source 1230, and the first optical system 1240 may be substantially the same as the first reflection light source 210, the first transmission light source 220, the first scattering transmission light source 230, and the first optical system 240, respectively, which are described with reference to FIG. 2.

According to some embodiments, unlike the first transmission light source 220 of FIG. 2, no diodes may be arranged at both ends of the first transmission light source 1220 and aligned to the second optical system 1340.

Two directions substantially parallel to the bottom surface G₁₁ of the cover glass G₁ are referred to as a first direction (an x direction) and a second direction (a y direction). The first direction (the x direction) and the second direction (the y direction) may be substantially perpendicular to each other. The first direction (the x direction) may be a direction in which a pair of opposing edge portions G₁₂ of the cover glass G₁ extend. The first direction (the x direction) may be a direction in which the side edge portions G₁₃ extend. The second direction (the y direction) may be a direction in which the front and rear edge portions G₁₄ and G₁₅ extend. The third direction may be a direction perpendicular to the first and second directions (the x and y directions). The directions indicated by arrows in the drawings and directions opposite thereto refer to the same direction. The definitions of the aforementioned directions are the same in all subsequent figures.

The second sub optical module 1300 may include a first edge portion transmission light source 1320 and a second optical system 1340. According to some embodiments, the second optical system 1340 may be different from the first optical system 1240. According to some embodiments, the second optical system 1340 may have a greater depth of field than the first optical system 1240. According to some embodiments, the second optical system 1340 may be coupled to a first driving device. According to some embodiments, the first driving device may adjust a position and tilt of the second optical system 1340 in response to a command from the control module 400. An inclination of the second optical system 1340 refers to an inclination in the second direction (the y direction) with respect to the third direction (the z direction).

The first edge portion transmission light source 1320 may emit light that reaches the second optical system 1340 through the side edge portions G₁₃. The first edge portion transmission light source 1320 may be coupled to a second driving device. According to some embodiments, the second driver may adjust the position and tilt of the edge portion transmission light source 1320 in response to commands from the control module 400. A tilt of the edge portion transmission light source 1320 means a tilt in the second direction (the y direction) with respect to the third direction (the z direction).

According to some embodiments, since the positions and the tilts of the first edge portion transmission light source 1320 and the second optical unit 1340 vary, the second sub optical module 1300 may inspect various types of cover glasses G₁ having edge portions with different curvatures.

The third sub optical module 1700 may include a second reflection light source 1710, a second transmission light source 1720, a second scattering transmission light source 1730, and a third optical system 1740. The second reflected light source 1710, the second transmitted light source 1720, the second scattered transmitted light source 1730, and the third optical system 1740 may be substantially the same as the second reflective light source 310, the second transmission light source 320, the second scattered transmission light source 330, and the second optical system 340, respectively, described with reference to FIG. 2.

The fourth sub optical module 1800a may include a second edge portion transmission light source 1820 and a fourth optical system 1840.

According to some embodiments, the fourth optical system 1840 is similar to the edge optical system 360 described with reference to FIG. 2, and may be coupled to a third driver. According to some embodiments, the third driving device may adjust a position and tilt of the fourth optical system 1840 according to the command of the control module 400. A tilt of the fourth optical system 1840 means the tilt in the second direction (the y direction) with respect to the third direction (the z direction).

According to some embodiments, the second edge portion transmission light source 1820 is similar to the third transmission light source 350 described with reference to FIG. 2, and may be coupled to a fourth driver. According to some embodiments, the fourth driver may adjust a position and tilt of the second edge portion transmission light source 1820 in response to commands from the control module 400. A tilt of the second edge portion transmission light source 1820 means a tilt in the second direction (the y direction) with respect to the third direction (the z direction).

According to some embodiments, since the positions and the tilts of the second edge transmission light source 1820 the fourth sub optical module 1800 vary, the third sub optical module 1700 may inspect various types of cover glasses G₁ having edge portions with different curvatures.

However, exemplary embodiments are not limited thereto. For example, referring to FIG. 9B, the fourth sub optical module 1800b may include a plurality of second edge portion transmission light sources 1820 and a fourth optical systems 1840. According to some embodiments, the fourth sub optical module 1800b includes two second edge portion transmission light sources 1820 and two fourth optical systems 1840, corresponding to the front G₁₃ and rear edge portions G₁₅, respectively.

FIG. 13 is a schematic block diagram for explaining a cover glass manufacturing apparatus according to some embodiments.

Referring to FIG. 13, a cover glass manufacturing apparatus 10000 according to some embodiments may include an inspection apparatus 11000, a cleaning apparatus 12000, and a processing apparatus 13000. According to some embodiments, the inspection apparatus 11000 may include the cover glass inspection apparatus 10 described with reference to FIGS. 1 to 4, the cover glass inspection apparatus 50 described with reference to FIG. 5, the cover A glass inspecting apparatus 60, or the cover glass inspecting apparatuses 70a and 70b described with reference to FIGS. 8 to 10. The inspection apparatus 11000 may perform inspection of the cover glass.

The cleaning apparatus 12000 may be an apparatus for cleaning the cover glass. According to some embodiments, the cleaning apparatus 12000 may clean the cover glass using megasonic cleaning, ultra megasonic cleaning, or the like. According to some embodiments, the cleaning apparatus 12000 may include a plurality of water tanks for cleaning the cover glass.

The processing apparatus 13000 may perform a single process or a plurality of processes for producing a cover glass of an end product or an intermediate product. According to some embodiments, the processing apparatus 13000 may perform processes such as forming, polishing, chamfering, coating, and the like, but is not limited thereto

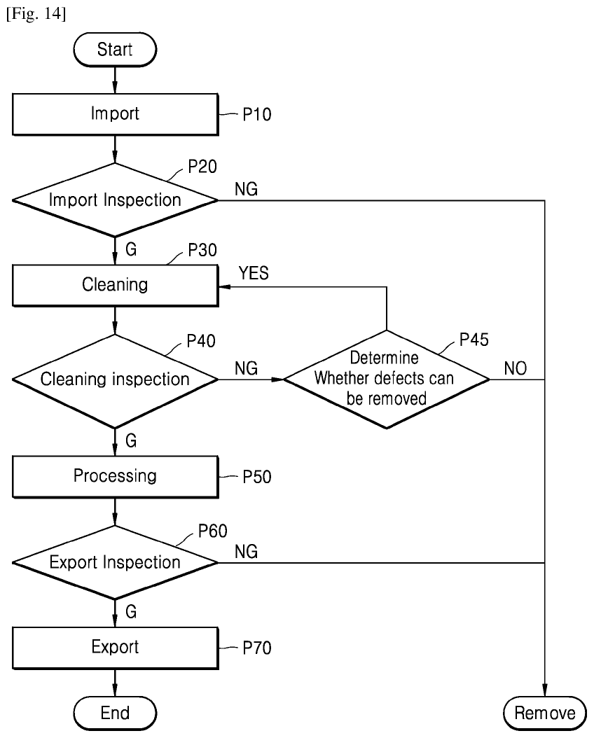

FIG. 14 is a flowchart for explaining a method of manufacturing a cover glass according to some embodiments.

Referring to FIGS. 13 and 14, in P10, raw materials for making cover glass may be supplied to a cover glass manufacturing apparatus 10000 including a cover glass inspection apparatus according to some embodiments.

Then, in P20, the supplied raw materials may be loaded into the inspection apparatus 11000 along a first import arrow i1 and may be inspected by the inspection apparatus 11000. According to some embodiments, inspection of the raw materials may be performed in substantially the same manner as the inspection method described with reference to FIGS. 2 to 4.

The cover glass determined as being good (G) in P20 may be loaded into the cleaning apparatus 12000 along a first export arrow e1, and the cover glass determined as not being good (NG) may be removed from the cover glass manufacturing apparatus 10000 along a removal arrow r.

In P30, the cleaning apparatus 12000 may clean the loaded cover glass. The cleaned cover glass may be loaded in the inspection apparatus 11000 along a second import arrow i2.

In P40, the inspection apparatus 11000 may perform a cleaning inspection. The cleaning inspection may be performed in substantially the same manner as the inspection of the raw materials. If the cover glass is determined as being good (G) in P40, the cover glass may be loaded into the processing apparatus 13000 along a second export arrow e2, and if the cover glass is determined as not being good (NG) in P40, the inspection apparatus 11000 may subsequently determine whether removal of the defect is possible.

If the defect of the cover glass is determined to be removable in P45 (YES), the cover glass may be loaded into the cleaning apparatus 12000 along the first export arrow e1 and cleaned again. If the defect of the cover glass is determined not to be removable in P45, the cover glass may be removed from the cover glass manufacturing apparatus 10000 along the removal arrow r.

In P50, the processing apparatus 13000 may perform subsequent processing such as molding, polishing, chamfering, coating, and the like on the cover glass. The processed cover glass may be loaded into the inspection apparatus 11000 along a third import arrow i3.

In P60, the inspection apparatus 11000 may inspect the cover glass that is to be discharged. The inspection in P60 may be substantially the same as the inspection in P20. The inspection of the cover glass that is to be discharged may be a process to process of determining failure of the cover glass as a finished product or a process in another manufacturing stage. According to some embodiments, if the cover glass is determined as being good (G) in P60, the cover glass is discharged along the third export arrow e3 in P70. If the cover glass is determined as not being good (NG), the cover glass may be removed along the removal arrow r.

According to the above embodiments, since a defect is detected by capturing an image of a cover glass during transfer of the cover glass, a process time may be reduced.

Furthermore, since the position, size, or formation range of a defect are detected, reliability of inspection results may be improved.

Furthermore, total inspection of a cover glass having curved edge portions along one surface or opposite lateral sides thereof may be possible.

Furthermore, information about a defect of a cover glass may be provided to a user terminal.

It should be understood that the embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

1. A cover glass inspecting apparatus comprising:
a transfer module for transferring a cover glass, wherein the cover glass includes a flat plate portion extending in first and second directions crossing each other and edge portions protruding in a third direction perpendicular to the first and second directions and connected to an outer circumference of the flat plate portion, wherein the flat porting includes first and second surfaces facing each other;
a first optical module for photographing the first surface;
a second optical module for photographing the second surface; and
a control module for reading images of the cover glass taken by the first optical module and the second optical module,
wherein the first optical module includes:
a first sub optical module for photographing the first surface; and
a second sub optical module for photographing the edge portions.

2. The cover glass inspecting apparatus of claim 1, wherein the edge portions include:
first edges extending in the first direction; and
second edges extending in the second direction,
wherein the second sub optical module photographs the first edge portions while the transfer module transfers the cover glass in the first direction.

3. The cover glass inspecting apparatus of claim 2,
wherein a length of the first edge portions in the first direction is greater than a length of the second edge portions in the second direction.

4. The cover glass inspecting apparatus of claim 2, wherein the first sub optical module includes:
at least one of a transmission light source, a scattering transmission light source, a reflection light source, and a diffusion light source; and
a first optical system for photographing the first surface,
wherein the second sub optical module includes:
at least one of a transmission light source and a scattering transmission light source; and
a second optical system for photographing the first edge portions, wherein the second optical system is different from the first optical system.

5. The cover glass inspecting apparatus of claim 4,
wherein a depth of field of the second optical system is greater than a depth of field of the first optical system.

6. The cover glass inspecting apparatus of claim 4,
wherein the second optical systems comprises a plurality of second optical systems.

7. The cover glass inspecting apparatus of claim 4,
wherein first optical system is inclined in the first direction with respect to the third direction, and the plurality of second optical systems are inclined in the second direction with respect to the third direction.

8. The cover glass inspecting apparatus of claim 4,
wherein the plurality of second optical systems are connected to a driving device configured to adjust a position and a tilt of the plurality of second optical systems.

9. The cover glass inspecting apparatus of claim 4,
wherein the second optical module includes:
a third sub optical module for photographing the second surface; and
a fourth sub optical module for photographing the second edge portions.

10. The cover glass inspecting apparatus of claim 9,
wherein a photographing manner of the first to third sub optical modules is different from a photographing manner of the fourth sub optical module.

11. The cover glass inspecting apparatus of claim 9,
wherein a photographing manner of the first to third sub optical modules is line scanning, and a photographing manner of the fourth sub optical module is shot photographing.

12. The cover glass inspecting apparatus of claim 9, wherein
the first sub optical module includes:
a first reflection light source arranged at a distance from the first surface, the first reflection light source irradiating light to be reflected on the first surface in a direction tilted with respect to the third direction;
a first transmission light source arranged at a distance from the second surface and irradiating light to be transmitted through the second surface in a tilted direction with respect to the third direction; and
a plurality of first scattering transmission light sources arranged in a plurality of rows between the first transmission light source and the transport module and irradiating light to be scattered by the second surface and transmitted through the second surface,
wherein the third sub optical module includes:
a second reflection light source arranged at a distance from the surface, the second reflection light source irradiating light to be reflected on the second surface in a direction tilted with respect to the third direction;
a second transmission light source arranged at a distance from the first surface and irradiating light to be transmitted through the first surface in a tilted direction with respect to the third direction; and
a plurality of second scattering transmission light sources arranged in a plurality of rows between the second transmission light source and the transport module and irradiating light to be scattered by the first surface and transmitted through the first surface.

13. The cover glass inspecting apparatus of claim 9,
wherein the second sub optical module includes a first edge portion transmission light source arranged at a distance from the first edge portions and irradiating light to be transmitted through the first edge portions of the cover glass,
wherein the fourth sub optical module includes a second edge portion transmission light source arranged at a distance from the second edge portions and irradiating light to be transmitted through the second edge portions of the cover glass.

14. A cover glass inspecting apparatus comprising:
a transfer module for transferring a cover glass including a flat plate portion including a first surface and a second surface facing each other and a protruding portion protruding from a central portion of the second surface;
a first optical module for photographing the protruding portion, the first optical module including a first transmission light source, a first reflection light source, and a first scattering light source, the first optical module;
a second optical module for photographing the first surface, the second optical module including a second transmission light source, a second reflection light source, and a second scattering light source;
a third optical module for photographing the second surface, the third optical module including a plurality of third scattering light sources; and
a control module for reading images of the cover glass photographed by the first to third optical modules.

15. The cover glass inspecting apparatus of claim 14,
wherein the plurality of third scattering light sources are arranged along an outer circumference of the second surface.

16. The cover glass inspecting apparatus of claim 15,
wherein the first surface and the second surface are rectangular, the protruding portion is rectangular parallelepiped, and the plurality of third scattering light sources are arranged in two or four rows along the outer circumference of the second surface.

17. The cover glass inspecting apparatus of claim 15,
wherein the first surface and the second surface are circular and have a first circumference, the protruding portion is cylindrical and has a second circumference less than the first circumference, and the plurality of third scattering light sources are arranged along a virtual circular circumference.

18. A method of manufacturing a cover glass, the method comprising;
supplying a cover glass to an inspection module;
performing a first inspection on the cover glass;
cleaning the cover glass on which the first inspection was performed;
performing a second inspection on the cleaned cover glass;
performing at least one of shaping, polishing, chamfering, and coating on the cover glass on which the second inspection was performed; and
performing a third inspection on the processed cover glass,
wherein the cover glass includes a flat plate portion and a protruding portion protruding from the flat plate portion,
wherein each of the first to third inspections includes inspecting the flat plate portion and the protruding portion.

19. The method of claim 18,
wherein the inspecting the flat portion includes inspecting the flat portion via a Schlieren method using at least one of transmission illumination, reflection illumination, and scattering illumination.

20. The method claim 18,
wherein the inspecting the protruding portion includes inspecting the protruding portion via a Schlieren method using at least one of transmission illumination, and scattering illumination.
